(19) United States
(12) Patent Application Publication
(10) Pub. No.: US 2014/0110447 A1
(43) Pub. Date: Apr. 24, 2014

(54) COLLAPSIBLE REMOVABLE SHELF WITH COMPARTMENT

(71) Applicants: Bruce Hilley, Pike Road, AL (US); Roderic N Uphaus, Troy, AL (US)

(72) Inventors: Bruce Hilley, Pike Road, AL (US); Roderic N Uphaus, Troy, AL (US)

(73) Assignee: Bruce Darryl Hilley, Pike Road, AL (US)

(21) Appl. No.: 13/657,785

(22) Filed: Oct. 22, 2012

(51) Int. Cl. B62B 5/00

(52) U.S. Cl. CPC B62B 5/00
USPC 224/401

(57) ABSTRACT

This invention is a collapsible, detachable shelf for two-wheeled hand trucks, as well as other hand-propelled utility vehicles, designed to provide users with a table-like work surface and storage compartment. The shelf adapts universally to all existing models and brands of hand trucks and convertible carts, by use of clamps using hanging rods or like methods. Further original hand truck and shelf designs may accommodate new shelves, thus excluding clamp usage. The work surface benefits occupations, including but not limited to stock clerks and delivery persons, providing portable workspace suitable for writing and holding paper and office supplies. An alternate shelf has a storage compartment which holds job-appropriate items such as scanning devices, hand-held computers, pricing guns, and printers. The shelf, in its collapsed position, lies recessed within or behind the vehicle, providing no interference with normal freight.

### CROSS-REFERENCE TO RELATED APPLICATIONS

Application Ser. No. 61/549,432; Priority of which is claimed based on previous filing of Provisional Patent Filing Date Oct. 20, 2011

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the field of Hand Trucks.

No prior art was found, and the problem I am addressing with the present invention has yet to be solved. I have noticed delivery people with their hand trucks in one hand and their paperwork or computer in the other hand, trying to maneuver their way through parking lots, doorways, crowded store aisles, and up stairs. Why do they not have a place on the hand truck to attach the paperwork, computer, price gun, or items they are trying to carry? Would it not make their life much easier to use both hands while driving their cart? Millions of these carts are currently on the market, and to offer a new cart would be a great solution, but would there be a way to retro-fit the existing vehicles that are on the market today? To accomplish this task, more than one version of this device will need to be offered, because there is more than one type of hand truck, cart, U-boat, and hand-propelled vehicle.

### SUMMARY OF THE INVENTION

The present invention relates to a shelf or tray, and more particularly is an invention that may be used by, but is not confined or restricted to, people who frequently deliver product, goods, or services, and are carrying items such as paperwork, personal office supplies, a handheld computer, handheld printer, pricing gun, and any other related items, while pushing hand-propelled vehicles. The present invention, simply put, is a shelf or tray mountable on a hand truck, 2 wheeled dolly, U-boat cart, or like vehicles, either by using a clamp, creating a hole in the leg or post of the hand truck, or any other like method. This shelf will extend perpendicularly from the vehicle and serve as a portable work space. When finished with work or paperwork, the collapsible shelf swings down and locks into place, and is out of the load bearing area of the cart.

### BRIEF DESCRIPTION OF THE DRAWINGS

FIG. 1 shows extended perspective view from the front, of the shelf that goes onto carts made of round tubular material.

FIG. 2 shows extended perspective view of shelf in FIG. 1 from the front with shelf open

FIG. 3 a front collapsed view of the same shelf

FIG. 3b shows a shelf mounted directly into tubular members of hand truck

FIG. 4 is a side extended perpendicular view of same shelf

FIG. 5 is a detailed view of the mechanical workings and clamps used for trays attached onto carts made from round tubular material.

FIG. 6 side view of clamp from FIG. 5 showing hand knob screw

FIG. 7 opposite side view of clamp showing round opening

FIG. 8 shelf with lid from FIG. 1-4, between clamps mounted on each hand truck leg

FIG. 9 shelf shown from top without lid

FIG. 10 rear view of hand truck having square members, with shelf mounted

FIG. 11 perspective view of hand truck and shelf from FIG. 10

FIG. 12 spring steel latch

FIG. 13 view of shelf holding handheld computer, printer, paper

FIG. 14 top view of shelf in FIG. 13

FIG. 14b side view of forward bent hardened steel plate 239

FIG. 15 back view of shelf from FIG. 13, 14 mounted on clamps

FIG. 16 clipboard shelf open view

FIG. 17 back view of shelf from FIG. 16 mounted on clamps

FIG. 18 angle view of clamp from FIG. 13, 15, 17 designed for truck having square members

FIG. 19 close-up view of shelf from FIG. 13, 14, 15

FIG. 20 close-up side view of shelf from FIG. 19

FIG. 21 side view of clipboard shelf from FIG. 16, 17 lining up with clamp FIG. 18

FIG. 22 side view of same as FIG. 21, from a perpendicular sliding angle

FIG. 23 perspective view of hand truck and clipboard shelf

FIG. 24 rear view of FIG. 23

FIG. 25 extended closed clipboard shelf front view

FIG. 26 collapsed side view of FIG. 23

FIG. 27 shelf from FIG. 1, 2, 3 positioned before extended view 4

FIG. 28 shelf from FIG. 1, 2, 3 after moved back into extended position view 4

FIG. 29 clamp from FIG. 18 prior to mounting

FIG. 30 clamp from FIG. 18, 29 mounted on square member

FIG. 31 clamp back view

FIG. 32 shelf sliding straight down into latch from back of hand truck

FIG. 33 bottom of shelf meeting spring steel latch

FIG. 34 shelf after having cleared latch in FIG. 32 and resting in collapsed position

### DETAILED DESCRIPTION OF THE INVENTION

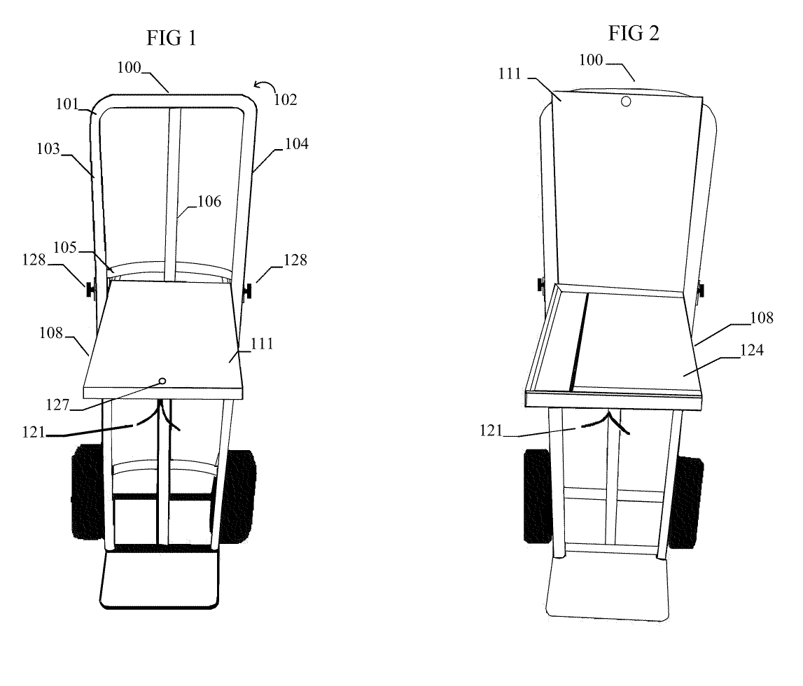

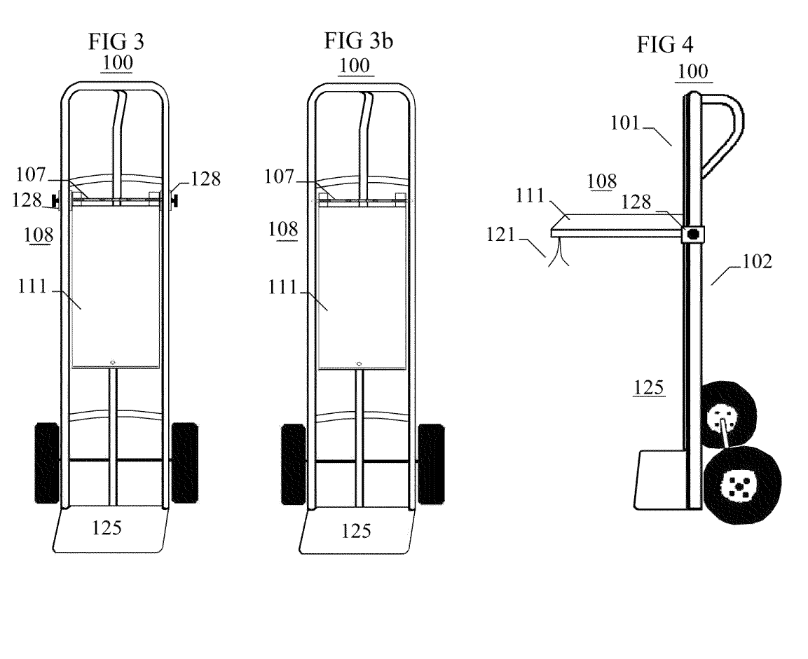

Referring now to the invention in more detail, in FIG. 1 shows a hand truck 100, having a front side 101 and a backside 102, with a shelf 108 FIG. 1, 2, 3, 4 attached thereto. This type of hand truck has round support members and provides a support surface that is curved inwards. The hand truck 100 has a first leg 103, a second leg 104, a vertical support member 106, and a cross member 105. A removable support member 107 is reversibly attached to the hand truck legs FIG. 3b by being placed directly into round openings or holes in the tubular legs 103, 104. A removable support member 107 FIG. 3, 5, 8 is reversibly attached to the legs using clamps 128. The shelf 108 is suspended from the 2 clamps 128 FIG. 1, 4, 5, 6, 7, 8 in its collapsed position FIG. 3, 3b by this support member 107.

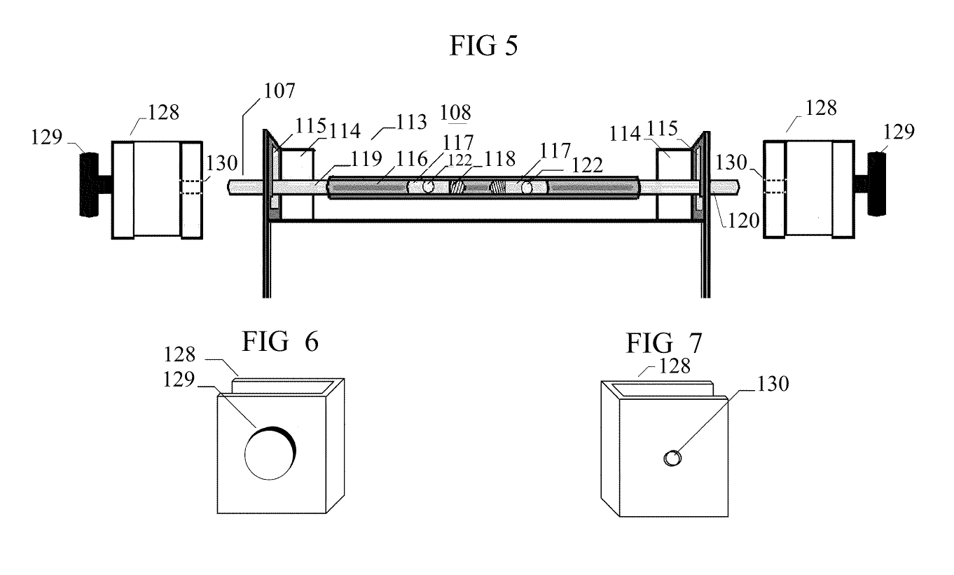

FIG. 9 shows the shelf 108 is constructed from a U-shaped frame 112 having a back 109, two legs 114 and a back frame member 110 connecting the two free ends of legs 114. There is a space or open end 113 from the back frame member and the end of the legs 114 FIG. 5, 9. The support member 107 FIG. 5, 8 passes through the ends of the legs 114 through elongated openings 115. FIG. 5 the support member 107 is constructed from a hollow tube 116 having two elongated open slots 117 and a spring 118. A first metal rod 119 is positioned slidably into one open end of the hollow tube, a compression spring 118 is inserted into the other end of the hollow tube 116 and then a second metal rod 120 is positioned slidably, or slid into the same open end of the hollow tube 116. A handle 122 is fastened to each metal rod 119, 120 and the handles protrude through the elongated openings 117. The handles 122 hold the rods 119, 120 inside the tube 116, and allow the rods 119, 120 to be pushed together.

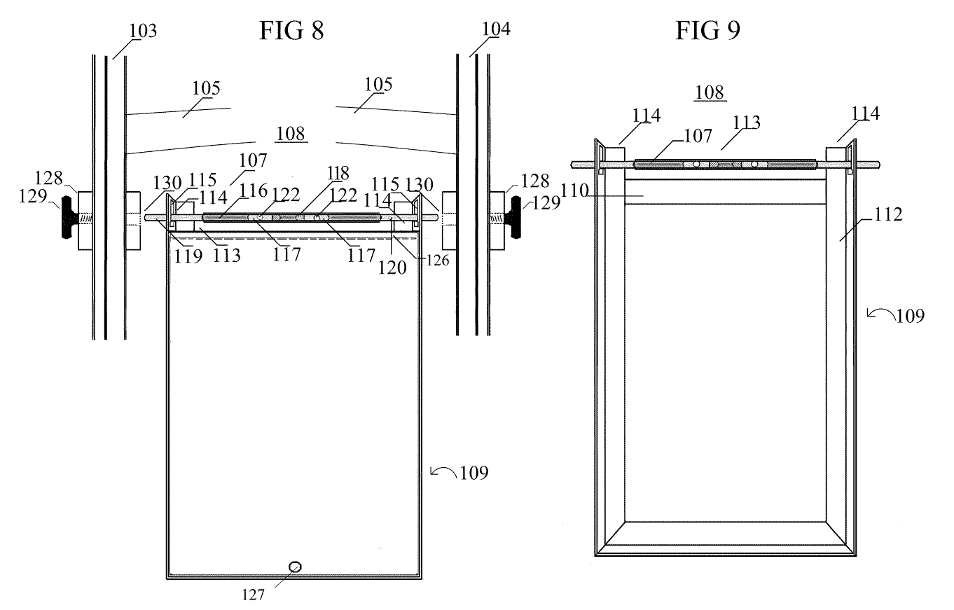

Clamps 128 FIG. 6. 7 are mounted FIG. 8 on each member 103, 104 in an area below the cross member 105. Clamps 128 made to fit the diameter of the round tubular hand truck 100 are mounted by tightening a Hand Knob Screw 129 into the outside wall of both legs 103, 104 FIG. 8 of the U-shaped clamp 128 until it is firmly gripped onto the leg. Clamps shown mounted with shelf 108 attached in FIG. 1-4. FIG. 6, shows the clamp 128 with a hand knob screw 129 on the side. FIG. 7 shows the same clamp 128 has a round opening or hole 130 in the opposite side large enough for the rods 119, 120 to penetrate, illustrated in FIG. 5, 8. FIG. 8 shows how the support member 107 will be reversibly attached to the hand truck legs 103, 104, by the rods 119, 120 going into the openings 130 of the clamps 128. The hollow tube 116 FIG. 5, 8 has a spring 118 in its interior positioned between the first metal rod 119 and the second metal rod 120. The spring 118 biases the metal rods 119, 120 away from each other and out from the hollow tube 116. The handles 122 allow a user to push the two metal rods 119, 120 together to shorten the overall length of the support member 107 to prepare it for mounting. In this manner the support member 107 can be inserted through the elongated openings 115 in the ends of the legs 114 of the U-shaped frame 112, as shown in FIG. 5, 8, and then into the holes 130 in the clamps 128, mounted on the legs 103, 104 of the hand truck 100.

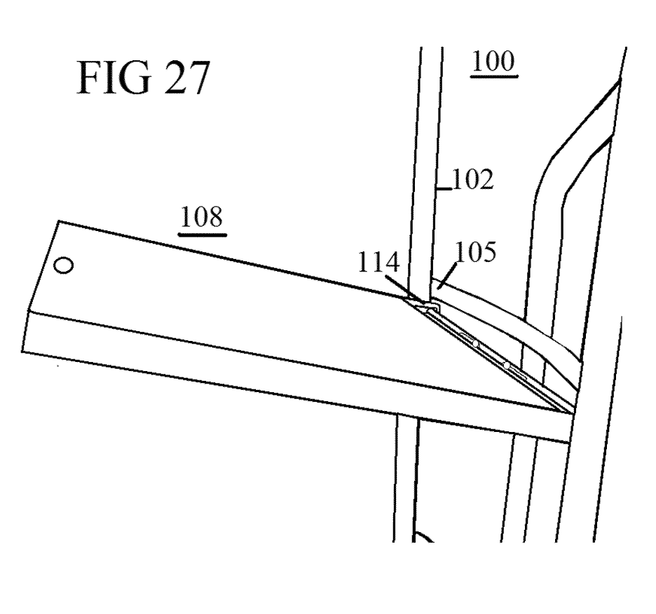

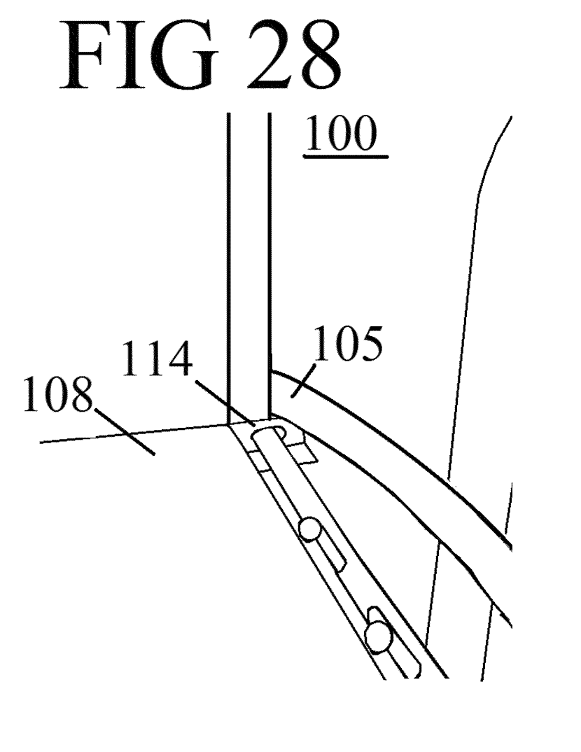

FIG. 28 show the shelf 108 pushed towards the cross member 105 so that the ends of the legs 114 of the U-shaped frame 112 pass under the cross member 105. In this configuration the shelf 108 cannot rotate downward and remains in a position perpendicular to the hand truck 100 so that the shelf 108 may be used FIG. 1, 4. It is placed into this position by rotating the front of the shelf upward FIG. 27 and then pushing the entire shelf 108 towards the backside 102 of the hand truck 100 so that the ends of the legs 114 move under the cross member 105. It is possible for a notch to be placed in this leg 114 to help secure it into place, if necessary. When pulled away from the cross member 105, the shelf 108 can be rotated downward for storage, FIG. 3, and out of the load bearing area 125 FIG. 3, 3b, 4 of hand truck 100. Fastening straps 121 FIG. 1, 2, 4 may be used as a method of securing the shelf 108 to the vertical support member 106. It is possible to use a different method to secure the shelf in this collapsed state FIG. 3, 3b.

FIG. 2 shows a top view of the shelf 108 with the lid 111 opened, showing the interior 124 of the shelf 108. Dividers 125 can be placed within the interior 124 of the shelf 108. FIG. 8 further shows a rod hinge 126 upon which the lid 111 rotates to open and close the shelf 108. There is a need for access to the inside of the shelf 124 FIG. 2, this shelf 108 has a round opening, or hole 127 in the front part of the lid 111 FIG. 1, 2. It is possible for a secure latch to be added.

### DETAILED DESCRIPTION OF SHELF OR TRAY FOR OTHER HAND TRUCKS

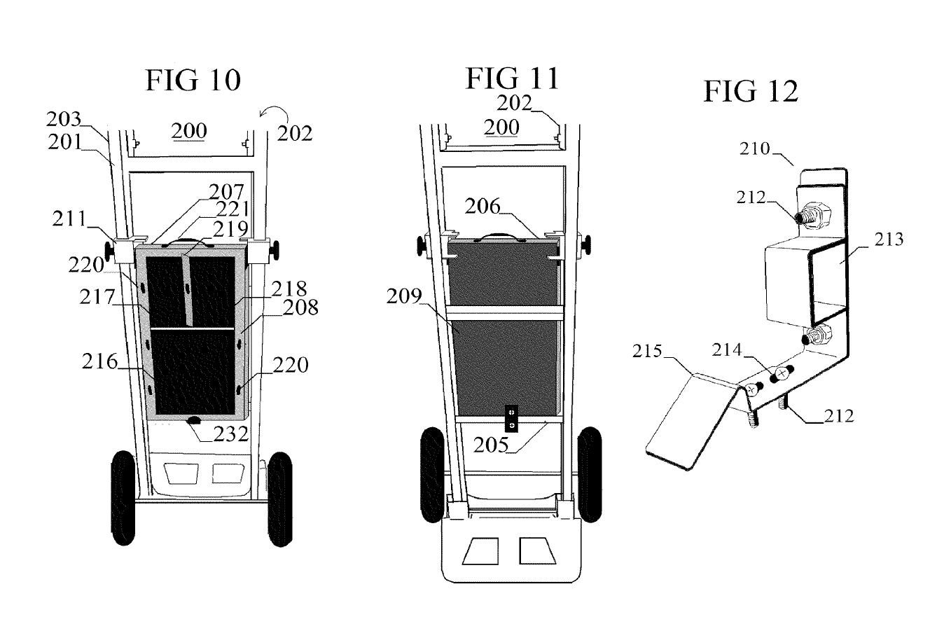

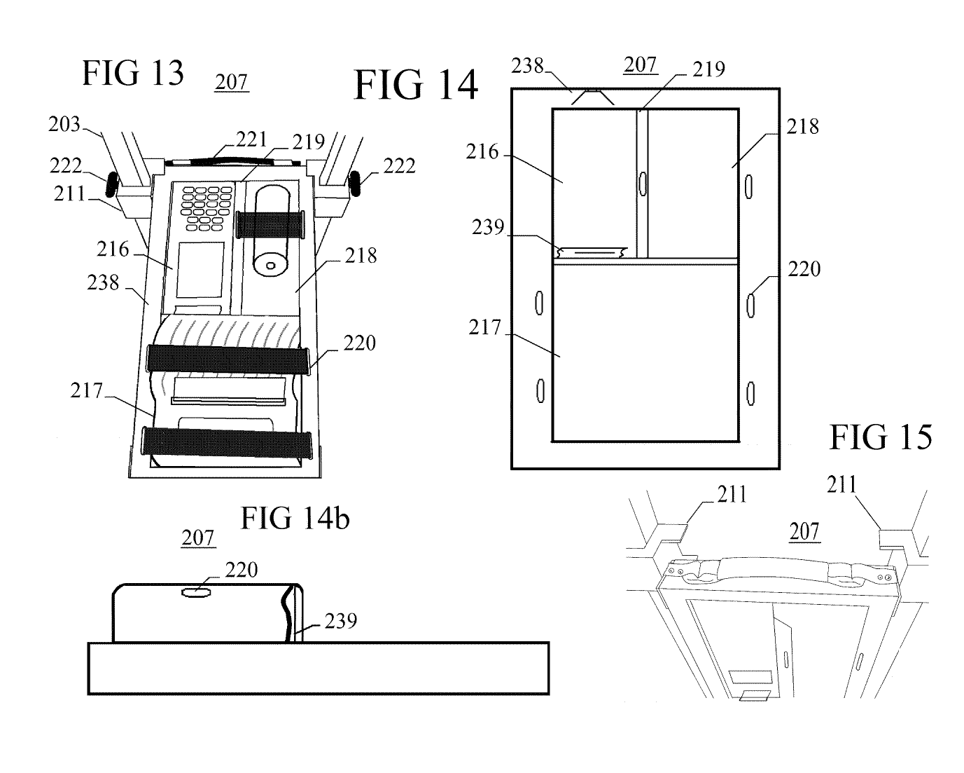

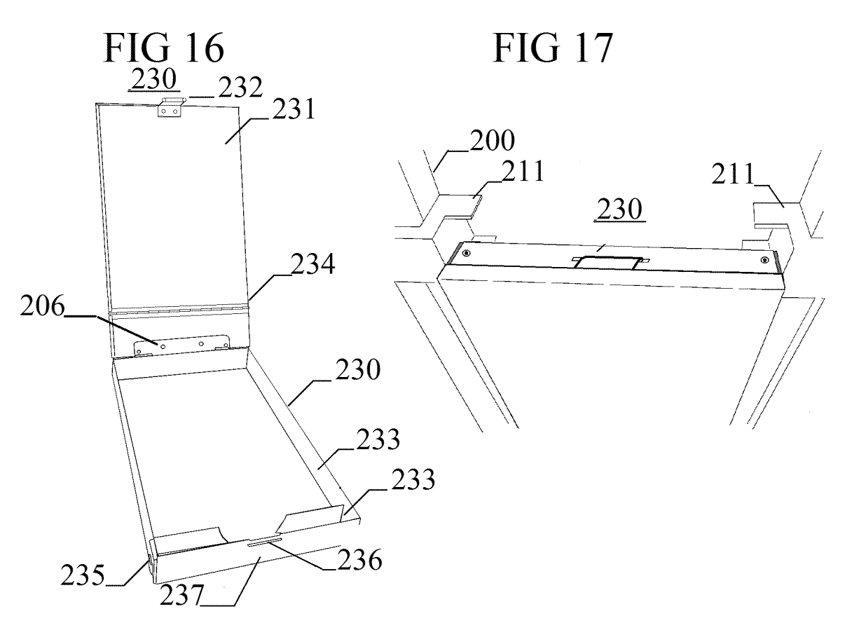

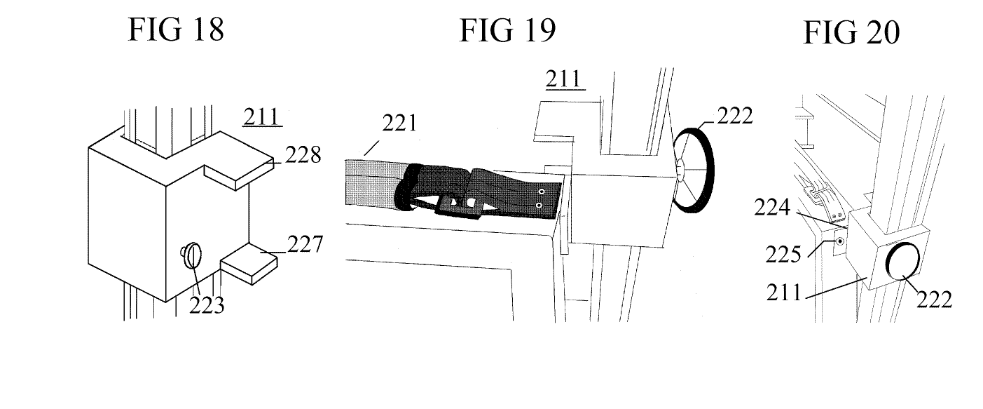

FIG. 10 shows a hand truck 200 viewed from the front 201, and the same hand truck 200 in FIG. 11 is shown from the back side 202. This hand truck has square support members, and provides a flat carrying surface. This hand truck 200 has in FIG. 10, 11 a first leg 203 and a second leg 204. Clamps FIG. 18-22 are attached to the legs 203, 204. The clamps 211 hold a shelf or tray 207, 230 FIG. 10, 11, 13, 15, 17, 23, 24, 25 onto the hand truck 200 securely either in a collapsed position FIG. 10, 11, 15, 17, 23, 24, 26 or in a perpendicular position FIG. 13, 25. There are two types of shelves or trays: a shelf or tray that will be used primarily as a clipboard and an office caddy type device 207 FIG. 13, 14, and a shelf or tray that will be used to store or hold electronics, tools, or other devices or things that need to accompany someone 230 FIG. 16, 17.

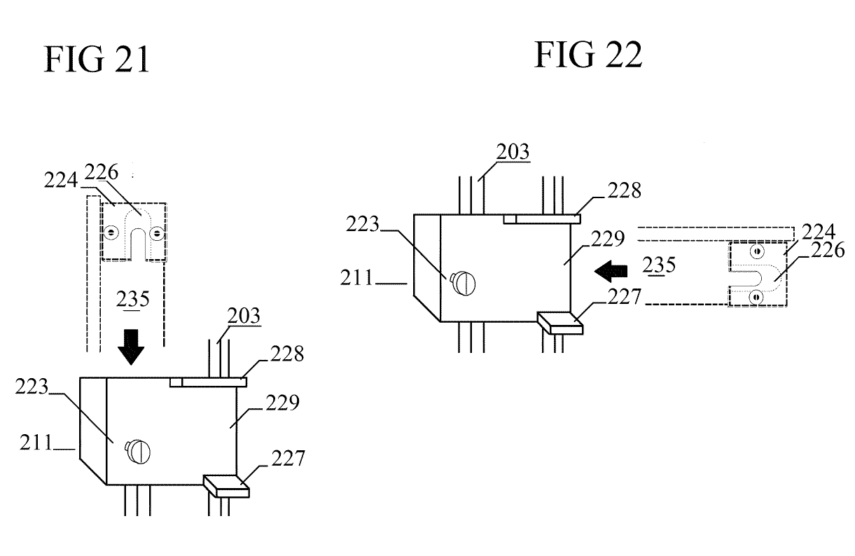

Clamps 211 FIG. 10, 11, 13, 18, 19, 20, 21, 22 allow retro-fit to most hand trucks with square members. A clamp 211 will have a hand knob screw 222 FIG. 19, 20 to fasten the clamp to the leg 203, 204 Fig. A rounded hanging rod 223 will allow the shelf 207, 230 to hang in the collapsed position, or pivot between the collapsed and perpendicular position. A bottom horizontal shelf support 227 and a top horizontal shelf support 228 FIG. 18, 21, 22 allow the shelf's hanging plate 224 FIG. 21, 22 to line up with the hanging rod 223. These supports 227, 228 also hold the shelf 207, 230 in the perpendicular position.

Shelf 207 was designed to hold electronics, specifically a handheld computer and a portable, rechargeable Bluetooth enabled printer. This shelf may be reconfigured, perhaps with a lid or cover, to hold any type of tool such as a pricing gun, hardware tools, or anything of this proportional size that is often used or carried by people while they have access to or are using a hand truck.

This shelf 207 has a front 208 FIG. 10, a back 209 FIG. 11. Three compartments 216, 217, 218 and a divider 219 FIG. 10 are added to separate components. Slots 220 FIG. 10, 14 have been machined into the top side surfaces allowing for strap fasteners to hold in the devices. A handle 221 FIG. 10, 13, 19 on the end makes it easy to grab and carry. To hold the computer in tightly, spring steel was inserted on the inside of the shelf 238 FIG. 14. This opposing force holds the computer inside its compartment when inserted under the forward bent hardened steel divider 239 FIG. 14B. Paper rolls, or other products FIG. 13 218 are held into their compartment by strap fasteners placed through the slots 220.

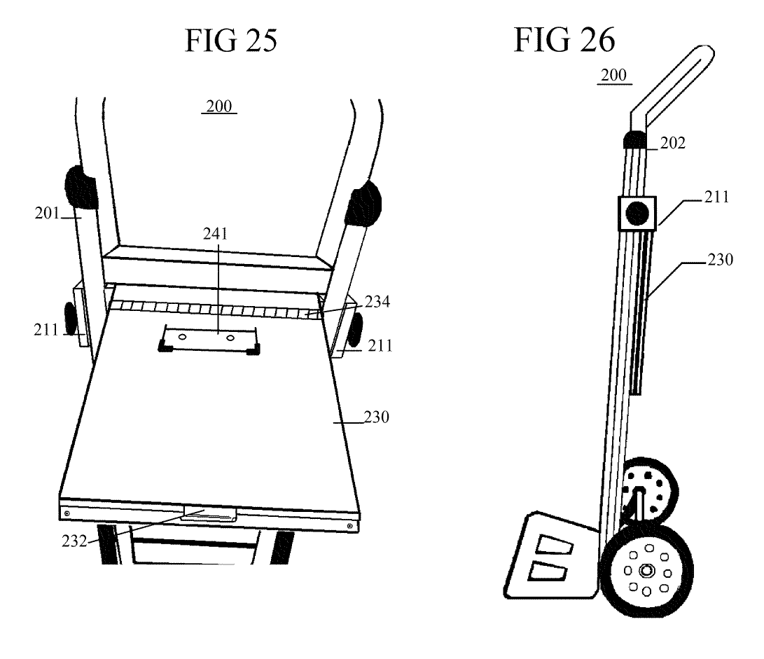

Shelf or tray 230 is a rectangular box with a lid 231 hinged 206 FIG. 16 in the rear, with a second hinge 234 FIG. 16, 25 between the first hinge 206 and the latch FIG. 16, 25 232. On the lid 231 is mounted FIG. 24, 25 a strong coiled spring-clamping action vertical paper stop 241. This shelf 230 is designed with compartments 233 to separate items carried inside. There is a front 237 with a slot 236 prepared to receive the latch 232 when in the closed position FIG. 25. Each side 235 will have attached or affixed near the front 237 a hanging plate 224 on which the shelf 230 will hang in a collapsed position from the hand truck 200 FIG. 10, 11, 13, 17, 23, 24, 25.

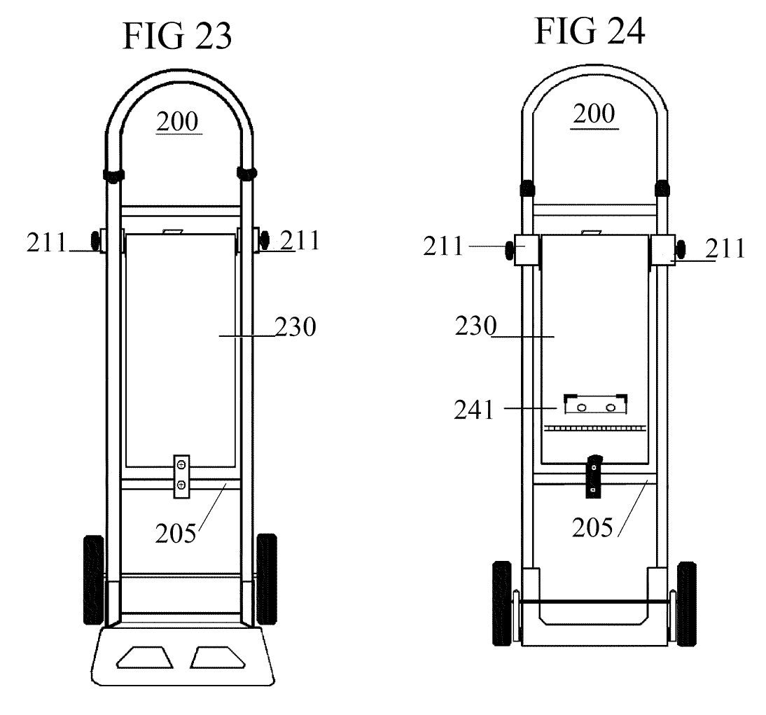

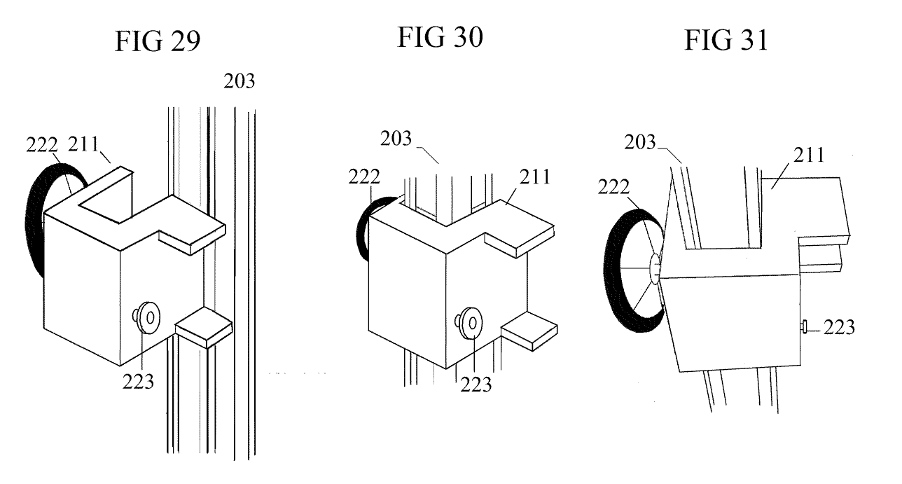

To place a shelf 207, 230 on the hand truck 200, the clamps 211 must first be mounted onto the legs 203, 204 of the hand truck, cart, U-boat or other and propelled vehicle. This is easily done by sliding a clamp 211 onto a leg 203 FIG. 29 while the hand knob screw 222 FIG. 19, 20, 29, 30, 31 is in an unscrewed position. When the clamp 211 is completely mounted onto leg 203 FIG. 30, 31, the clamps 211 are considered to be in a mounting position. The knob 222 is then tightened FIG. 31 into the leg 203 until clamp 211 is firmly secured on the vehicle. This is to be done on both sides in an equally measured position from the lower cross member 205 FIGS. 10, 23, and 24.

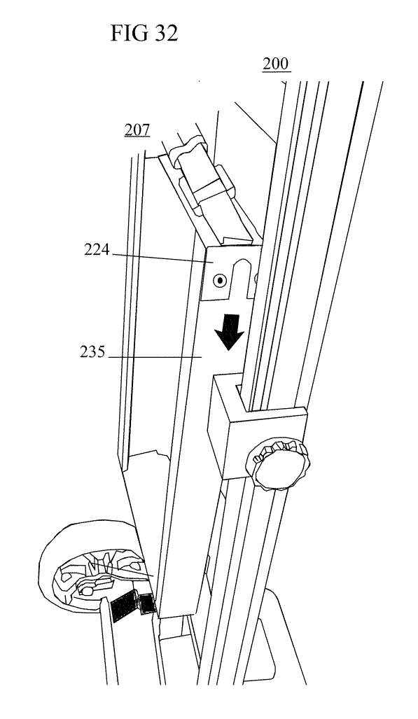

The shelf 207, 230 may be mounted onto the clamp 211 in two ways FIG. 21, 22. The first way would be to slide the shelf 207, 230 downward into a hanging position FIG. 21, lining up the hanging plate 224 FIG. 32 with the hanging rod 223 that is fastened onto the clamp FIG. 18, 29, 30, 31. The hanging rod 223 slides along the side 235 of the shelf 207, 230 FIG. 32 until it meets the hanging plate 224 and is guided into a machined cavity or pouch 226 where it can firmly hold the shelf 207, 230 in a hanging collapsed secure position FIG. 10, 11, 22, 24, 26. This is referred to as the collapsed position. The shelf 207, 230 will rest in a collapsed position FIG. 10, 11, 22, 24, 26 on the back side 202 of the hand truck 200, and the back part of the clamps 211 when the hand truck 200 is in use.

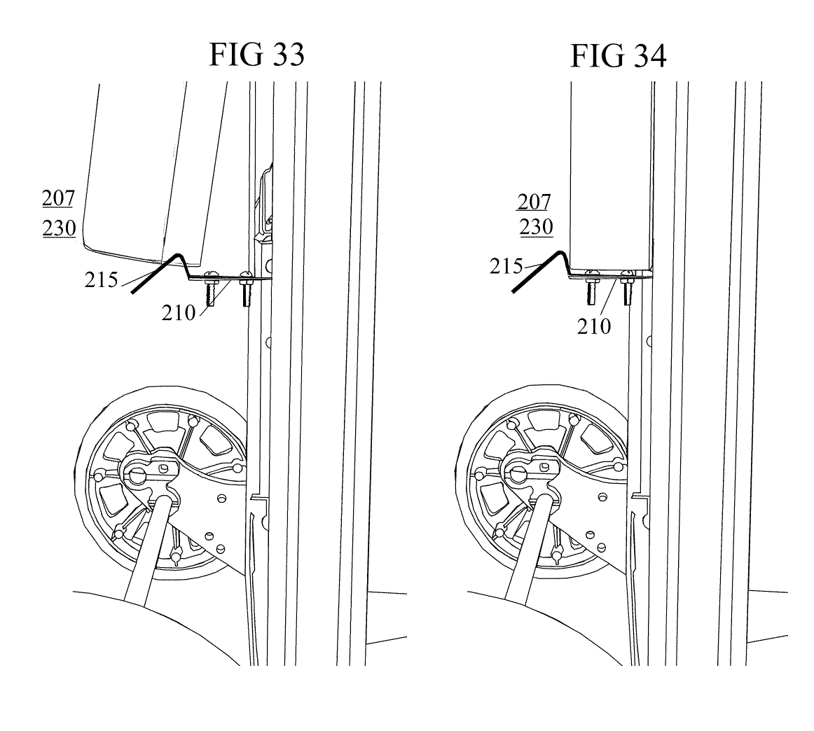

To remove the shelf 207, 230 from this position simply lift up, or reverse the previous motion, and the shelf 207, 230 will be easily removed. The shelf 207, 230 may be locked into a secure position when it makes contact with FIG. 33 the spring steel latch 210. This latch 210 is attached to the hand truck 200 through an opening 213 around the lower cross member 205. This latch 210, made from 2 pieces of hardened spring steel, is bent into the desired shape, and slots 214 allow the latch 210 to be adjusted forward or backward, and upward or downward. The latch is angled downward 215 in the front to allow the shelf 207, 230 to push the latch downward FIG. 33, when it the shelf 207, 230 swings into its' secure position. The shelf 207, 230 pushes down the spring steel latch 210 until the front of the shelf 207, 230 has passed over the latch 210, and then it will pop up into a latching position FIG. 34, securing the shelf 207, 230 in its resting or collapsed position FIG. 34.

From the collapsed position the shelf 207, 230 may be pivoted backwards toward the latch 210 until the shelf 207, 230 touches the latch. Still going further, FIG. 12 while the latch 215 is being pressed down FIG. 33, the shelf 207, 230 may be moved in an outward circular motion until the entire shelf is in a perpendicular position, and it then may be pushed forward

FIG. 25. When the shelf 207, 230 is pulled back, the hanging rods 223 are to be kept tight in their pouch 226, at a point where the shelf 207, 230 is horizontal, and perpendicular to the hand truck 200, the shelf 207, 230 may be slid into the clamps 211 to go forward between the bottom horizontal support 227 and the top horizontal support 228 FIG. 22. Sliding the shelf 207, 230 forward until the desired portion is on the front side 201 of the hand truck 200 FIG. 13, 25 creates a great opportunity for hands free writing, order entry, printing, or the like. The clipboard 230 is hinged 234 FIG. 16, 25 in an area that will allow the shelf 230 to be held by the clamps 211 in a perpendicular position FIG. 25 and still to be able to open up and operate much as it does in FIG. 4. Pulling the shelf 207, 230 forward and away from the hand truck 200 will allow the use of the shelf 207 and clipboard 230 as a separate tool, apart and away from the hand truck. To re-attach, simply hold shelf 207, 230 in a horizontal position (the same position the shelf 207, 230 was in when it was pulled off of the clamps 211 earlier), and slide the shelf 207, 230 in between the bottom horizontal support 227 and the top horizontal support 228 FIG. 22. Keep a steady backward sliding motion until the hanging plate 224 contacts the hanging rod 223 and slides into the machined pouch or cavity 226. The shelf 207, 230 will make a downward, swinging motion and should press down the latch 210 FIG. 33 and lock into place FIG. 34.

The construction details of the invention as shown above are that the shelves 108, 207, 230 may be made of aluminum or of any other sufficiently rigid and strong material such as high-strength plastic, metal, and the like. Further, the various components of the clamps 128, 211 can be made of different materials.

The advantages of the present invention would be to help one's work become more productive and allow a person to carry more items in fewer trips. Currently no prior art is found on a collapsible removable shelf with a compartment, and there are many advantages to having this item mounted on a hand truck. The shelf 108 may be used as an extra work station. Many convenience stores and other locations may not have adequate space for a work area, and this shelf can be used in a small proximity. The storage inside is a great way to store paperwork, and to organize any office supplies needed on the job. The clipboard shelf 230 provides a great writing surface, a lightweight work surface when mounted, and will open to organize paperwork and office supplies. The shelf 207 holds various types of items including, but not limited to handheld computers, portable printers, barcode scanners, pricing guns, tools, RFID readers and any other device or item it can be configured or designed to house. Since all of these are removable they can be used on or off of the hand truck. They may be used in the delivery truck, in the store, in the office, or at home.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Further, while the hanging rod and plate is a method of securing the shelf to the hand truck, current and future development may incorporate various methods of attaching the shelf to the hand truck, dolly, cart, or other hand propelled vehicle.

We claim:

1) a collapsible removable shelf designed to mount on a hand truck made of round tubular members
a) with the shelf having a spring-tensed rod as a support member to reversibly attach it to the hand truck, hinging, or hanging from the rods,
b) and the shelf will be removable from the spring-tensed rods,
c) being made from metal, plastic, or another hard and durable, preferably lightweight material,
d) having a smooth surface for writing and possibly an alternate non-smooth surface for a work environment,
e) being adaptable to fit into clamps manufactured and made for the specific use of fitting the shelf to a hand truck, dolly, cart, or other hand propelled vehicle,
f) have a lid or cover, and an inside, with or without compartments,
and so the shelf will be designed to go on hand trucks made from round tubular steel, or hard material, with specially made clamps.

2) claimed item 1, a collapsible removable shelf designed to mount on a hand truck made of round tubular members with clamps
a) with the shelf having a spring-tensed rod as a support member to reversibly attach it to the hand truck, hinging, or hanging from the rods,
b) and the shelf will be removable from the spring-tensed rods,
c) being made from metal, plastic, or another hard and durable, preferably lightweight material,
d) having a smooth surface for writing and possibly an alternate non-smooth surface for a work environment,
e) being adaptable to fit into clamps manufactured and made for the specific use of fitting the shelf to a hand truck, dolly, cart, or other hand propelled vehicle,
f) have a lid or cover, and an inside, with or without compartments,
g) having clamps with sufficient strength to support shelf by means of tightening the clamp to the walls of the legs of the hand trucks
h) with the clamps being universally adaptable to all sizes of hand trucks made from tubular steel,
i) and the clamps having an opening to accompany the hinging rod of the shelf,
and so the shelf will be designed to go on hand trucks made from round tubular steel, or hard material, and it will be joined using specially made clamps or other devised methods.

3) a collapsible removable shelf designed to mount on a hand truck made with square members
a) with the hand truck having square aluminum, metal, or durably structural vertical members,
b) with the shelf being made from a durable material,
c) and the shelf being designed to fit the hand truck, by going on the side members, or on the horizontal members
d) the shelf being removable, and reversibly attachable,
e) and having an inside, with or without compartments,
f) with the shelf being designed as industry-specific, or as a generic shelf,
g) being designed to hold tools, papers, or any hand carried object,
h) with compartments for scanning device, or any electronic device
i) having a lid or cover,
whereas the hand truck will have a collapsible removable shelf.

4) claimed item 3, the a collapsible removable shelf designed to mount on a hand truck made with square members with clamps
a) with the hand truck having square aluminum, metal, or durably structural vertical members,
b) with the shelf being made from a durable material,
c) and the shelf being designed to fit the hand truck, by going on the side members, or on the horizontal members
d) the shelf being removable, and reversibly attachable,
e) and an inside, with or without compartments,
f) with the shelf being designed as industry-specific, or as a generic shelf,
g) being designed to hold tools, papers, or any hand carried object,
h) with compartments for scanning device, or any electronic device,
i) having a lid or cover,
j) with the clamps being universally adaptable to all sizes and shapes of square and rectangular hand trucks,
k) with the clamps being made with a durable metal or hard plastic or a suitable material,
whereas the hand truck will have a collapsible removable shelf, that will be joined to the hand truck using specially made clamps or other devised methods.
